(19) United States
(12) Patent Application Publication
(10) Pub. No.: US 2012/0116807 A1
(43) Pub. Date: May 10, 2012

(54) Apparatus, system, and method for comparing healthcare

(75) Inventors: Christopher A. Hane, Irvine, CA (US); Vijay S. Nori, Roswell, GA (US); Jean W. Rawlings, Roy, UT (US); David R. Anderson, Chaska, MN (US); Regina Gogol, Brookline, MA (US); John M. Brillante, Wallingford, CT (US)

(73) Assignee: INGENIX INC., Eden Prairie, MN (US)

(21) Appl. No.: 13/200,462

(22) Filed: Sep. 23, 2011

Related U.S. Application Data
(60) Provisional application No. 61/404,211, filed on Sep. 29, 2010.

(51) Int. Cl. G06Q 50/22

(52) U.S. Cl. 705/3

(57) ABSTRACT

Methods, systems, and apparatuses for comparing healthcare data are disclosed. Some embodiments of the method for comparing healthcare data may include receiving healthcare data for geographic regions. The healthcare data may include healthcare variables and clinical data. Some embodiments of the method may further include analyzing, with a processing device, one or more healthcare variables for geographic regions. In some embodiments of the method, analyzing the one or more healthcare variables may include assigning each geographic region to one of several clusters based on the one or more healthcare variables. Some embodiments of the method may further include analyzing, with a processing device, the clinical data for geographic regions. In some embodiments of the method, analyzing the clinical data may include determining a primary magnitude for each geographic region of a primary measure, determining a secondary magnitude for each geographic region of a secondary measure, and comparing them.

This application claims priority to, and incorporates by reference in its entirety, U.S. Provisional Patent Application Ser. No. 61/404,211 entitled “Apparatus, System, and Method for Comparing Healthcare Data”, which was filed on Sep. 29, 2010.

### BACKGROUND OF THE INVENTION

1. Field of the Invention

This invention relates to comparing healthcare data and more particularly relates to an apparatus, system, and method for comparing healthcare data.

2. Description of the Related Art

There is no known capability that allows users to analyze healthcare access and service variables (e.g., the number of hospital beds per thousand or number of nurses per hospital bed) and clinical data at the same time. Currently, users may be able to analyze healthcare care access and service variables alone. For example, the Dartmouth Atlas of Healthcare (www.darmouthatlas.org) uses Medicare data to provide information and analysis about national, regional, and local markets, as well as hospitals and their affiliated physicians. The data from the Dartmouth Atlas of Healthcare may be used to compare variations in how medical resources are distributed and used in the United States.

At the same time, health insurance companies process, store, and analyze millions of health insurance claims on daily basis. In some instances, clinical data from health insurance claims may span several years. Analysis of clinical data may reveal information such as high-cost drivers within a population or individuals in certain regions are more susceptible to certain diseases.

No known tool exists that allows users to analyze and compare healthcare access and service variables and clinical data at the same time. This ability would enable users to not only identify the high-cost drivers or individuals in certain regions are more susceptible to disease, but also understand which access and service variables are contributors. Medical providers and insurance providers can utilize such an analysis to determine—at a granular level—whether there is a need to contract for more hospital beds, less primary care physicians, more specialists, etc., to reduce costs and provide a higher-quality of medical care.

### SUMMARY OF THE INVENTION

Methods for comparing healthcare data are disclosed. In some embodiments, method may include receiving healthcare data for geographic regions. In some embodiments, the healthcare data may include healthcare variables and clinical data. In some embodiments, the method may include analyzing, with a processing device, one or more healthcare variables for geographic regions. In some embodiments, analyzing the one or more healthcare variables may include assigning each geographic region to one of N clusters in response to the one or more healthcare variables, where N is a number greater than 1. In some embodiments, the method may include analyzing, with a processing device, the clinical data for geographic regions. In some embodiments, analyzing the clinical data may include determining a primary magnitude for each geographic region of a primary measure. In some embodiments, analyzing the clinical data may further include determining a secondary magnitude for each geographic region of a secondary measure. In some embodiments, analyzing the clinical data may further include comparing the primary magnitude to the secondary magnitude for each geographic region.

In some embodiments, analyzing the one or more healthcare variables may include displaying the analysis of the one or more healthcare variables.

In some embodiments, displaying the analysis of the one or more healthcare variables may include identifying which geographic region is defined to which one of N clusters. In some embodiments, displaying the analysis may further include identifying the one or more healthcare variables.

In some embodiments, the method may also include receiving one or more user inputs.

In some embodiments, analyzing the one or more healthcare variables may include an iterative process.

In some embodiments, the primary measure may include a target measure, and the secondary measure may include a control measure.

In some embodiments, analyzing the clinical data further may include displaying the analysis of the clinical data.

In some embodiments, displaying the analysis may include displaying the primary magnitude. In some embodiments, displaying the analysis may also include displaying the comparison of the primary magnitude to the secondary magnitude.

In some embodiments, displaying the primary magnitude may include illustrating a circle whose size correlates to the primary magnitude. Furthermore, in some embodiments, displaying the comparison may include shading the circle to correlate to the comparison.

Systems for comparing healthcare data are also disclosed. In some embodiments the system may include a data storage device configured to store healthcare data for geographic regions. In some embodiments of the system, the healthcare data may include healthcare variables and clinical data. In some embodiments, the system may include a server. In some embodiments of the system, the server may include a healthcare variable analysis module configured to analyze one or more healthcare variables for geographic regions. In some embodiments of the system, analyzing the one or more healthcare variables may include assigning each geographic region to one of N clusters in response to the one or more healthcare variables, where N is a number greater than 1. In some embodiments of the system, the server may also include a clinical data analysis module configured to analyze the clinical data for geographic regions. In some embodiments of the system, analyzing the clinical data may include determining a primary magnitude for each geographic region of a primary measure. In some embodiments of the system, analyzing the clinical data may also include determining a secondary magnitude for each geographic region of a secondary measure. In some embodiments of the system, analyzing the clinical data may also include comparing the primary magnitude to the secondary magnitude for each geographic region.

In some embodiments of the system, analyzing the one or more healthcare variables may include displaying the analysis of the one or more healthcare variables.

In some embodiments of the system, displaying the analysis of the one or more healthcare variables may include identifying which geographic region is defined to which one of N clusters. In some embodiments of the system, displaying the analysis may include identifying the one or more healthcare variables.

In some embodiments of the system, the system may also include a user-input module configured to receive one or more user inputs.

In some embodiments of the system, analyzing the one or more healthcare variables may include an iterative process.

In some embodiments of the system, the primary measure may include a target measure and the secondary measure may include a control measure.

In some embodiments of the system, analyzing the clinical data further may include displaying the analysis of the clinical data.

In some embodiments of the system, displaying the analysis may include displaying the primary magnitude and displaying the comparison of the primary magnitude to the secondary magnitude.

In some embodiments of the system, displaying the primary magnitude may include illustrating a circle whose diameter correlates to the primary magnitude. In some embodiments of the system, displaying the comparison may include shading the circle to correlate to the comparison.

Computer program products are also disclosed. In some embodiments, the computer program product may include a computer readable medium having computer usable program code executable to perform operations. In some embodiments, these operations may include receiving healthcare data for geographic regions. In some embodiments the operations may further include analyzing one or more healthcare variables for geographic regions and analyzing the clinical data for geographic regions.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

The patent or application file contains at least one drawing executed in color. Copies of this patent or patent application publication with color drawing(s) will be provided by the Office upon request and payment of the necessary fee.

FIG. 1 is a schematic block diagram illustrating one embodiment of a system for comparing healthcare data.

FIG. 2 is a schematic block diagram illustrating one embodiment of a database system for comparing healthcare data.

FIG. 3 is a schematic block diagram illustrating one embodiment of a computer system that may be used in accordance with certain embodiments of the system for comparing healthcare data.

FIG. 4 is a schematic logical diagram illustrating one embodiment of abstraction layers of operation in a system for comparing healthcare data.

FIG. 5 is a schematic block diagram illustrating one embodiment of an apparatus for comparing healthcare data.

FIG. 6 is a schematic block diagram illustrating one embodiment of an apparatus for comparing healthcare data.

FIG. 7 is a schematic flow chart diagram illustrating one embodiment of a method for comparing healthcare data in accordance with the present invention.

FIG. 8 illustrates one embodiment of a display for analyzing healthcare variables.

FIG. 9 illustrates one embodiment of a display describing a cluster when analyzing healthcare variables.

FIG. 10A-10B illustrate embodiments of a display for analyzing clinical data using bubbles.

FIG. 11A-11C are screenshot diagrams illustrating embodiments of user interface displays.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” as defined in Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

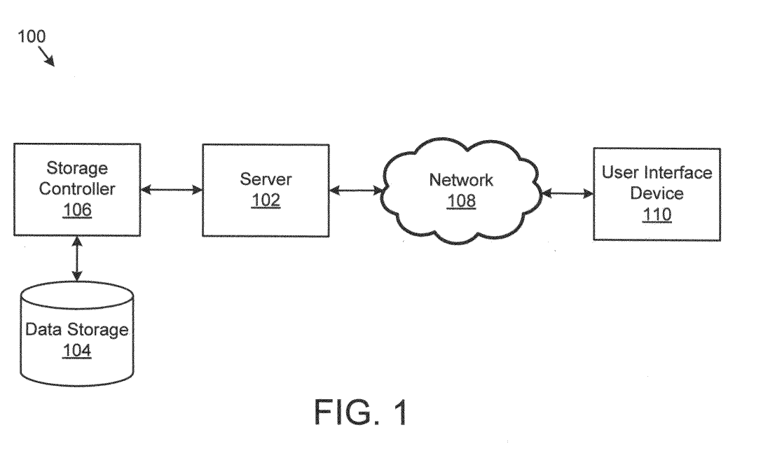

FIG. 1 illustrates one embodiment of a system 100 for comparing healthcare data. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may allow users to visualize and/or analyze different access and service variables related to healthcare at the same time they are analyzing clinical data such as medical costs and diagnosis data. Specifically, the system 100 may receive healthcare data for various geographic regions—the healthcare data including healthcare access and service variables and clinical data, analyze the healthcare access and service variables and analyze the clinical data.

In one embodiment, the user interface device 110 is referred to broadly and is intended to encompass a suitable processor-based device such as a desktop computer, a laptop computer, a tablet computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may choose diseases/symptoms, healthcare access variables to be analyzed, geographic regions to be analyzed, display options, and the like. Various different user inputs are discussed throughout the disclosure.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to receive healthcare data for geographic regions (including healthcare access and service variables and clinical data), analyze the healthcare access and service variables, and analyze the clinical data. The server 102 may further be configured to display the analysis of the healthcare access and service variables and the analysis of clinical data in user interface 110. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

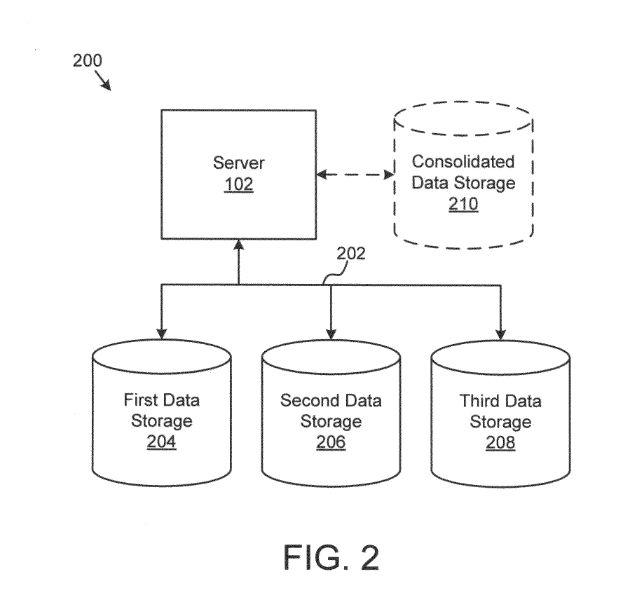

FIG. 2 illustrates one embodiment of a data management system 200 configured to store and manage healthcare data for comparison. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of healthcare access/service variables and clinical data. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements. The server 102 may store the consolidated data set in a consolidated data storage device 210. In such an embodiment, the server 102 may refer back to the consolidated data storage device 210. Alternatively, the server 102 may query each of the data storage devices 204-208 independently or in a distributed query. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 204-210; the server first communicating with a storage server or storage controller 106.

In one example of the system 200, the first data storage device 204 may store data associated with clinical data of one or more individuals or groups of individuals. Such clinical data may include data associated with medical services, procedures, and prescriptions utilized by the individual. In one particular embodiment, the first data storage device 202 includes clinical data gleaned from insurance claims data for over 56 million customers of a health insurance company. In one embodiment, the second data storage device 206 may store healthcare access and service variables. These healthcare access and service variables—sometimes referred to as “healthcare variables”—define different measures of healthcare access and supply information by geographic regions of the country.

The server 102 may host a software application configured for comparing healthcare data. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

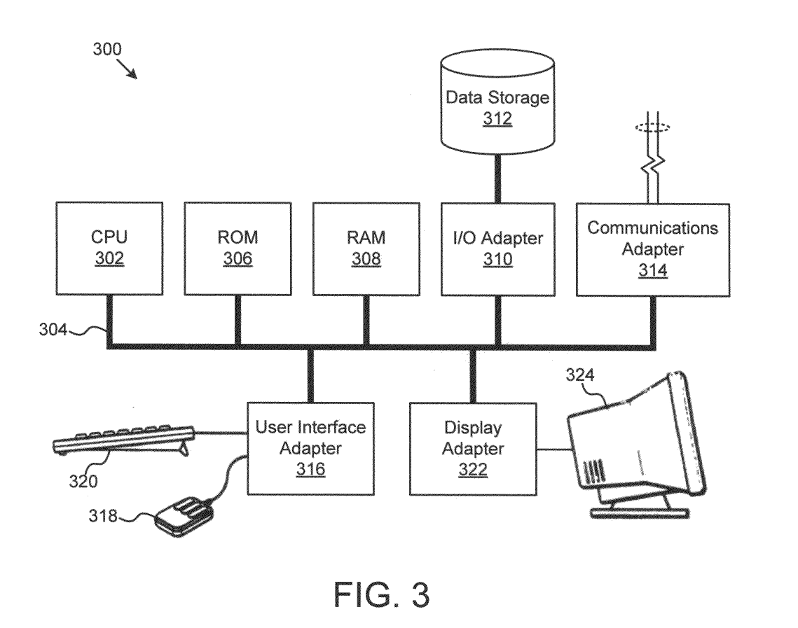

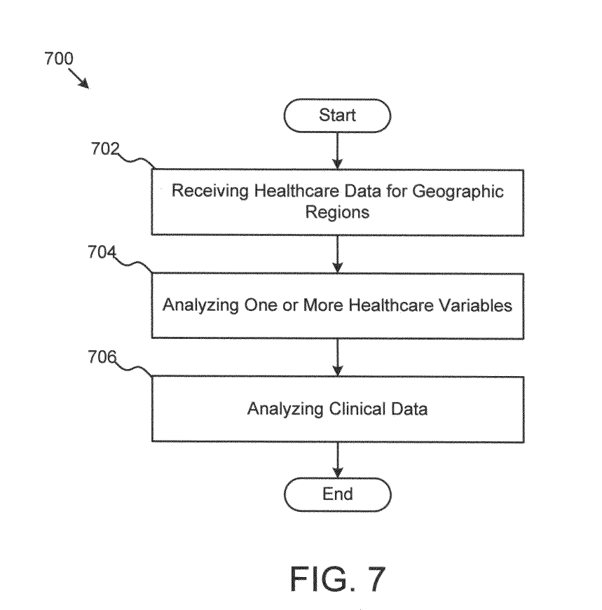

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIG. 7.

The computer system 300 also may include Random Access Memory (RAM) 308, which may be SRAM, DRAM, SDRAM, or the like. The computer system 300 may utilize RAM 308 to store the various data structures used by a software application configured to compare healthcare data. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information. In a further embodiment, the display adapter 322 may display a graphical user interface associated with a software or web-based application for comparing healthcare data.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

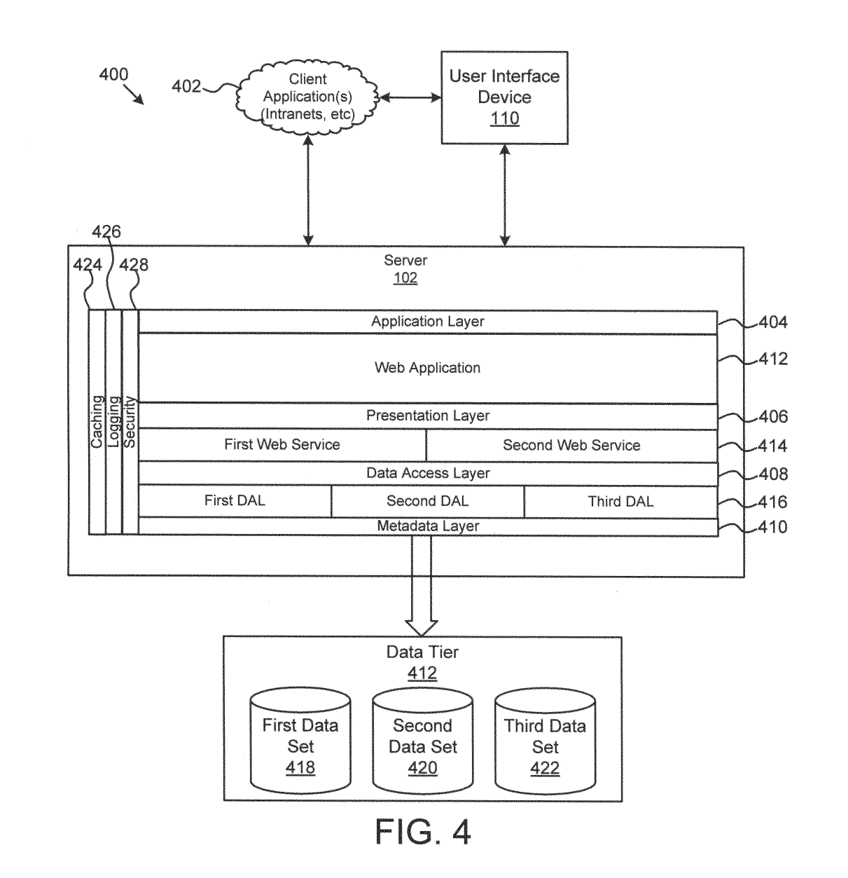

FIG. 4 illustrates one embodiment of a network-based system 400 for comparing healthcare data. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 422-422 that comprise a data layer or data tier 412. For example, a first data set 422, a second data set 420 and a third data set 422 may comprise a data tier 412 that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for comparing healthcare data that includes software modules configured to perform the method steps discussed with regards to FIG. 7.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 for comparing and visualizing the analysis of healthcare variable and clinical, or other information may access a first web service 414 for analyzing the data and a second web service 414 for computing the display. The web services 414 may receive healthcare data from a different web service or database. In response, the web service 414 may return data the comparison of healthcare data. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 412. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for a particular subset of healthcare variables or particular clinical data.

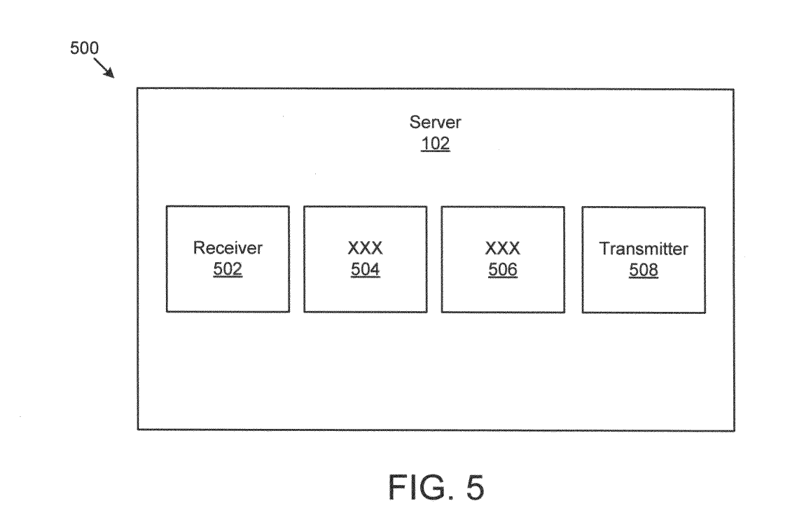

FIG. 5 illustrates a further embodiment of a system 500 for comparing healthcare data. In one embodiment, the system 500 may include a service provider site 502 and a client site 504. The service provider site 502 and the client site 504 may be separated by a geographic separation 506.

In one embodiment, the system 500 may include one or more servers 102 configured to host a software application 412 for comparing healthcare data, or one or more web services 414 for performing certain functions associated with comparing healthcare data. The system may further comprise a user interface server 508 configured to host an application or web page configured to allow a user to interact with the web application 412 or web services 414 for comparing healthcare data. In such an embodiment, a service provider may provide hardware 102 and services 414 or applications 412 for use by a client without directly interacting with the client's customers.

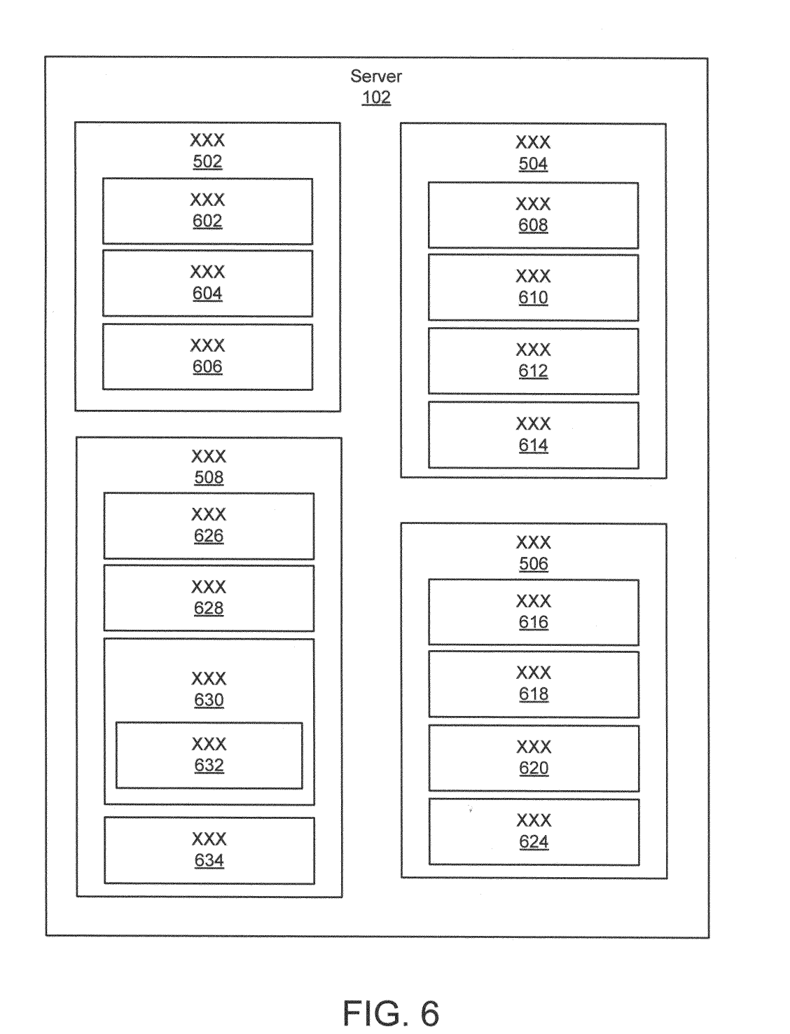

FIG. 6 illustrates one embodiment of an apparatus 600 for comparing healthcare data. In one embodiment, the apparatus 600 is a server 102 configured to load and operate software modules 602-608 configured for comparing healthcare data. Alternatively, the apparatus 600 may include hardware modules 602-608 configured with analogue or digital logic, firmware executing FPGAs, or the like configured to implement the method steps discussed with regard to FIG. 7.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 7 illustrates one embodiment of a method 700 for comparing healthcare data. In one embodiment, the method 700 starts by receiving 702 healthcare data for geographic regions. The healthcare data may include healthcare variables (sometimes referred to in this disclosure as “healthcare access and service variables”) and clinical data.

For example, one particular healthcare variable may measure the total number of physicians per 100,000 residents in a given region. In certain embodiments of the disclosed systems, methods, and apparatuses, the healthcare access and service variables are defined by the Dartmouth Atlas Working Group (www.darmouthatlas.org). The Dartmouth Atlas provides 45 different healthcare access and service variables by geographic regions with the United States. These 45 healthcare variables include:

TABLE 1
Healthcare Access and Supply Variables
Defined by Darthmouth Atlas

Acute Care Hospital Beds per 1,000 Residents
Hospital-based Registered Nurses per 1,000 Residents
FTE Hospital Employees per 1,000 Residents
Total Physicians per 100,000 Residents
Primary Care Physicians per 100,000 Residents
Total Specialists per 100,000 Residents
Medical Specialists per 100,000 Residents
Hospital-Based Physicians per 100,000 Residents
Surgeons per 100,000 Residents
Resident Physicians per 100,000 Residents
Allergists/Immunologists per 100,000 Residents
Anesthesiologists per 100,000 Residents
Cardiologists per 100,000 Residents
Cardiovascular/Thoracic Surgeons per 100,000 Residents
Critical Care Physicians per 100,000 Residents
Dermatologists per 100,000 Residents
Emergency Medicine Physicians per 100,000 Residents
Endocrinologists per 100,000 Residents
Family Practice Physicians per 100,000 Residents
Geriatricians per 100,000 Residents
General Surgeons per 100,000 Residents
Gastroenterologists per 100,000 Residents
Hematologists/Oncologists per 100,000 Residents
Infectious Disease Specialists per 100,000 Residents
Internal Medicine Physicians per 100,000 Residents
Neonatologists per 100,000 Residents
Nephrologists per 100,000 Residents
Neurosurgeons per 100,000 Residents
Neurologists per 100,000 Residents
Obstetrician/Gynecologists per 100,000 Residents
Ophthalmologists per 100,000 Residents
Orthopedic Surgeons per 100,000 Residents
Otolaryngologists per 100,000 Residents
Pathologists per 100,000 Residents
Pediatricians per 100,000 Residents
Plastic & Reconstructive Surgeons per 100,000 Residents
Psychiatrists per 100,000 Residents
Pulmonologists per 100,000 Residents
Radiologists per 100,000 Residents
Radiation Oncologists per 100,000 Residents
Physical Medicine/Rehabilitation Physicians per 100,000 Residents
Rheumatologists per 100,000 Residents
Urologists per 100,000 Residents
Vascular Surgeons per 100,000 Residents
Total Medicare A&B per enrollee

The Dartmouth Atlas measures these variables by hospital referral regions (HRRs). HRRs are regional market areas that contain at least one hospital that performs major cardiovascular procedures and neurosurgery. HRRs may be particularly useful when analyzing healthcare related data. In embodiments of the disclosed invention, the geographic regions may be defined as HRRs. One of skill in the art will recognize that geographic regions may also include cities, counties, states, countries, and/or other like geographic regions.

In some embodiments of the method, a user-input may be received defining which healthcare variables to consider. For example, a user may able to select, using a check box, which healthcare variables to analyze. In some embodiments, a user may select from a variety of profiles with a pre-defined set of healthcare variables. These profiles may include, without limitation, the overall profile, the hospital profile, the non-hospital profile, and the surgical profile. The overall profile may be based on all of the healthcare variables. The hospital profile may be based on several healthcare variables including number of hospital beds, nurses, hospital FTE employees, hospital-based physicians, surgeons, residents, anesthesiologists, and average Medicare Plan A&B cost per capita. The non-hospital profile may be based on several healthcare variables as shown in Table 2:

TABLE 2
Healthcare Variables Used in the Non-Hospital Profile

Total Physicians per 100,000 Residents
Primary Care Physicians per 100,000 Residents
Total Specialists per 100,000 Residents
Medical Specialists per 100,000 Residents
Allergists/Immunologists per 100,000 Residents
Anesthesiologists per 100,000 Residents
Dermatologists per 100,000 Residents
Emergency Medicine Physicians per 100,000 Residents
Endocrinologists per 100,000 Residents
Family Practice Physicians per 100,000 Residents
Geriatricians per 100,000 Residents
Gastroenterologists per 100,000 Residents
Infectious Disease Specialists per 100,000 Residents
Internal Medicine Physicians per 100,000 Residents
Obstetrician/Gynecologists per 100,000 Residents
Ophthalmologists per 100,000 Residents
Otolaryngologists per 100,000 Residents
Pediatricians per 100,000 Residents
Psychiatrists per 100,000 Residents
Physical Medicine/Rehabilitation Physicians per 100,000 Residents
Rheumatologists per 100,000 Residents
Total Medicare A&B per Enrollee

The surgical profile may be based on surgeons, cardiovascular/thoracic surgeons, general surgeons, neurosurgeons, orthopedic surgeons, plastic & reconstructive surgeons, vascular surgeons, and average Medicare Plan A&B cost per capita.

The clinical data may include a variety of medically-related patient information. For example, a database comprising insurance claim information history in a healthcare plan may include demographic data, insurance claims data, lab data, pharmacy data, race/ethnicity data, psychographic data, disability data, absenteeism data, workers compensation or the like. Different embodiments of the invention may include different types of clinical data. For example, a comparison of healthcare data analyzing diabetes by different geographic regions may necessitate different clinical data than an analysis of healthcare costs by geographic regions.

To facilitate the comparison of healthcare data, certain healthcare data may be standardized. This standardization process—sometimes referred to as normalization—helps compare variables of different magnitudes. For example, each of the healthcare variables to be analyzed may be standardized using Equation 1:

$$StandarizedHealthcareVariable = \frac{OriginalHealthcareVariable - Mean}{StandardDeviation} \qquad ( 1 )$$

As such, in some embodiments, Equation 1 may be used to calculate a StandardizedHealthcareVariable for each of the non-standardized variables (OriginalHealthcareVariable) for each geographic region. One of skill in the art will recognize other standardization/normalization techniques known in the art. Equation 1 is provided for example only, without limitation.

In some embodiments, the method 700 may also include analyzing 704 one or more healthcare variables. The analysis 704 of healthcare variables includes assigning each geographic region to a cluster in response to one or more healthcare variables. Geographic regions assigned to the same cluster will generally tend to be similar or share some feature(s). As such, clustering like-geographic regions helps compare the similarities and differences among the geographic regions with the same and different clusters. Embodiments of method 700 may include up to N clusters where N is a number greater than one. As such, in an embodiment where N equals 10, each of the geographic regions would be assigned to one of 10 clusters, and each of these 10 clusters would then contain like-geographic regions.

Geographic regions may be assigned to a cluster based on any number of healthcare variables. Simple clusters may only be based on one or two healthcare variables, and complex clusters may be based on several different variables. Analyzing one or two healthcare variables (i.e., using simple clusters) compares how the one or two variables vary across geographic regions. For example, an analysis using simple clusters may analyze the number of acute hospital beds per 1,000 residents across several geographic regions. Furthermore, in an embodiment where N equals 5, each geographic region may be assigned to one of five clusters characterizing the geographic region's availability of hospital beds: “very low,” “low,” “medium”, “high”, or “very high.” Thus, all the geographic regions in the “very low” cluster have a very low number of hospital beds per 1,000 residents when compared to other geographic regions, and similarly, all the geographic regions in the “very high” cluster have a high number of hospital beds per 1,000 residents when compared to other geographic regions.

In embodiments of the method using simple clusters, a variety of different techniques may be used to assign a geographic region to a cluster. In some embodiments, a ranged based method may be used. For example, for clusters representing acute hospital beds per 1,000 residents, the “very low” cluster may correspond to less than 1 hospital beds per 1,000 residents, the “low” cluster may correspond to 1-2 beds, the “medium” cluster may correspond to 2-3 beds, the “high” cluster may correspond to 3-4 beds, and the “very high” cluster may correspond to greater than 4 beds. In other embodiments, the various clusters may be percentage based, where the “very low” cluster corresponds to those geographic regions in the bottom 20% (when compared to the other geographic regions), the “low” cluster corresponds to those geographic regions in the next 20% and so on. A percentage base system may ensure that each cluster may have the same or similar number of like-geographic regions. One having skill in the art may recognize other techniques to assign a geographic region to a cluster when using one or two healthcare variable.

In some embodiments of the method using simple clusters, a ratio of two healthcare variables may be compared. For example, the ratio of the number of acute hospital beds per 1,000 residents to the number of hospital-based registered nurses per 1,000 residents may be compared. A similar technique can be used—either using percentages or ranges—to assign each geographic region to an appropriate cluster.

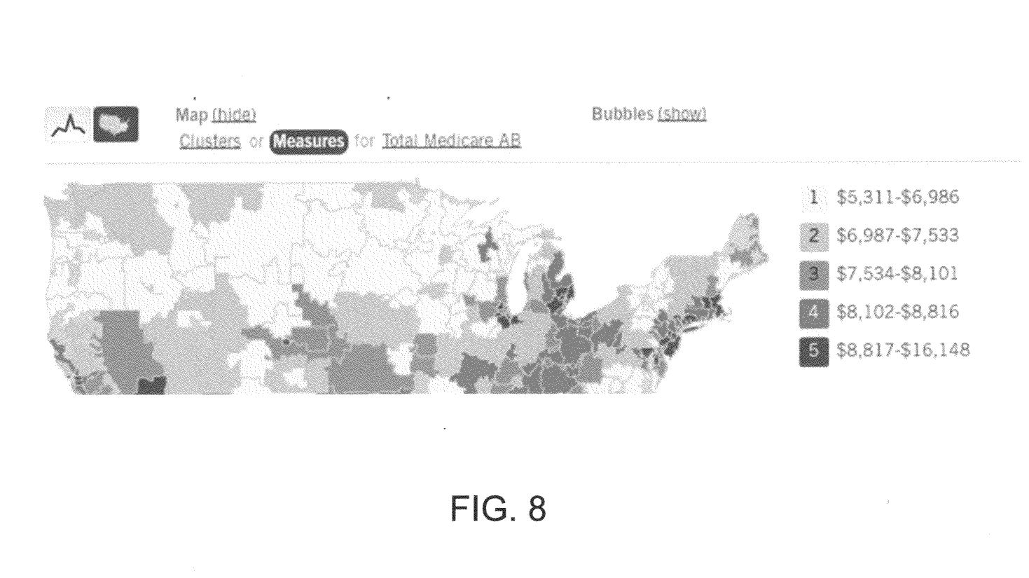

FIG. 8 illustrates an embodiment of a graphical user interface illustrating the analysis of healthcare variables using simple clusters. As shown, each of the geographic regions is assigned to one of 5 clusters. Each of the 5 clusters corresponds to a range of the averages of Medicare Plan A&B costs per Medicare enrollee. In this embodiment, the cluster assigned to each geographic region is indicated by a color scale, and specifically here a “heat scale.” As revealed from the analysis, many of the geographic regions in the northeastern United States have higher Medicare costs per enrollee when compared to those regions in the central-northern United States.

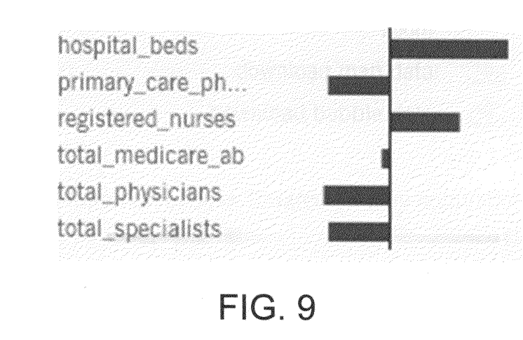

Complex clusters may be based on several different healthcare variables. For example, FIG. 9 provides an example embodiment of one such cluster. As shown, this cluster is based on 6 healthcare variables: hospital beds, primary care physicians, registered nurses, average Medicare Plan A&B cost per capita, total physicians, and total specialists. With regards to FIG. 9, the geographic regions assigned to that cluster have a much higher than average number of hospital beds and nurses per capita than the national average and a much lower number of primary care physicians, total physicians, and total specialists.

In embodiments of the method using complex clusters, a variety of different techniques may be used to assign a geographic region to a cluster. In some embodiments, the number of clusters is randomly assigned, and in other embodiments, the number of clusters may be user-selected. The given healthcare variables are then compared using statistics to determine which geographic regions are statistically the closest (or most similar). For example, k-means clustering and/or hierarchical clustering techniques can be used. One of skill in the art will recognize known clustering techniques to determine the statistical similarity of the geographic regions.

In some embodiments, geographic regions may be assigned to a cluster iteratively. For example, after assigning each geographic region to a cluster, only a small number (e.g., 2 or 3) of the most statistically similar clusters are kept. The geographic regions assigned to the remaining clusters are unassigned, and the assignment process may restart for those regions. In some embodiments, this iterative process may continue until the most statistically similar clusters in the most recent iteration are not as statistically similar as previous iterations.

Once each geographic region is assigned to a cluster, some embodiments of the method perform an error analysis. For example, one or more clusters may contain outliers (e.g., statistically dissimilar geographic regions). In some embodiments, more clusters may be added, and the step of assigning the geographic region to the cluster may be repeated.

In some embodiments, analyzing 704 the healthcare variables may further include displaying the analysis of the healthcare variables. As discussed with regards to FIG. 8, in some embodiments, the display may include a map. For example, the map may include each of the geographic regions, and each of the geographic regions may be colored (or like-wise identified) to correspond to the assigned cluster. In some embodiments, further user-inputs may be received by the method. For example, users may use a mouse to mouse-overs and/or click on a particular geographic region. User of a touch screen interface may simply touch a region. In response to such a user input, a pop-up window and/or hovering window may display to show the details of the cluster assigned to a specific geographic region. For example, with respect to FIG. 9, the pop-window may show the various healthcare variables used in the analysis 704. The window may further show whether the healthcare variables are above or below average as well as the magnitude of the variation. In some embodiments (not shown), the window may further show the exact value of each of the healthcare variables analyzed in the geographic region, the mean value of the healthcare variables across all geographic regions, and/or the mean value of the one or more healthcare variables across the geographic regions in the cluster. In some embodiments, each cluster may be given a name to describe the geographic regions assigned to that cluster. For example, with respect to FIG. 9, such a cluster may be named the “Most Beds Cluster” because the geographic regions assigned to that cluster have a higher than average number of hospital beds per capita.

Referring back to FIG. 7, method 700 continues by analyzing 706 clinical data for geographic regions. In some embodiments, method step 706 occurs after method step 704, and in other embodiments, the methods step 704 occurs after method step 706. In fact, in certain embodiments, the method steps are performed simultaneously.

In some embodiments, analyzing 706 clinical data for geographic regions includes determining a primary magnitude for each geographic region of a primary measure. Examples of primary measures include, without limitation, a measure of the frequency of a medical condition or disease, a measure of the frequency of a procedure or lab result, a measure of the type of prescription drug use, a measure of healthcare claims paid and/or unpaid, a measure of healthcare spending, and other like measures based on clinical data. Primary measures may also include demographic limitations. For example, a primary measure in one embodiment may be the measure of diabetes in African Americans over 30 years of age. Another example of a primary measure would be the measure of the use of specific drugs for depression among teens. One more example would be the measure of healthcare expenses.

Determining the primary magnitude of the primary metric includes quantifying the value of the measure within a geographic region. For example, the primary magnitude may be the number of people diagnosed with a disease in a given geographic region or the amount of dollars of healthcare spending in a given geographic region. Determining the primary magnitude may include known data mining techniques.

In some embodiments, analyzing 706 clinical data for geographic regions comprises determining a secondary magnitude for each geographic region of a secondary measure. The secondary measure may be used as a point of comparison for the primary measure. In the simplest embodiment, the secondary measure is the overall population in a given geographic region, and the secondary magnitude would be the overall population number. For example, a geographic region may have 10,000 people, and 100 people in the geographic region may have a particular medical condition. As such, the primary magnitude would be 100, the secondary magnitude would be 10,000, and a comparison of the primary magnitude to the secondary magnitude would reveal that 1% of the people in the geographic region are afflicted with the particular medical condition.

In some embodiments, the primary measure may include a target measure, and the secondary measure may include a control measure. Defining a target measure may include defining a target population, and as such, defining a control measure may include defining a control population. For example, in addition to determining the prevalence of a particular medical condition, defining a target population may include determining (through data mining or other techniques) demographic information about the population afflicted with the particular medical condition. Moreover, defining a control population may include finding (through data mining or other techniques) a population with matching demographic information, but without the particular medical condition. Determining the magnitude of the primary and secondary measures may then include quantifying the population of the target population and control population within a geographic region.

Several different comparisons and ratios can be made between the magnitude of the primary and secondary measures. For example, the magnitude of the target population may be compared to the overall population to determine the target population percentage within a geographic region. A similar comparison can be made with the control population to determine the control population percentage. A ratio can also be calculated between the primary magnitude and the secondary magnitude (e.g., a ratio of the target population to the control population).

In some embodiments, analyzing 704 the healthcare variables may further include displaying the analysis of the clinical data. Displaying the analysis of clinical data may include displaying the primary magnitude and displaying the comparison of the primary magnitude to the secondary magnitude. As discussed above, the comparison of the primary magnitude to the secondary magnitude can include any number of ratios and calculations. In some embodiments, displaying the primary magnitude may include illustrating a circle whose area correlates to the primary magnitude. In other words, each geographic region is represented by a circle (also referred to as a bubble), and the bigger the circle the larger the primary magnitude. Additionally, displaying the comparison may include shading the circle to correlate to the magnitude of the comparison.

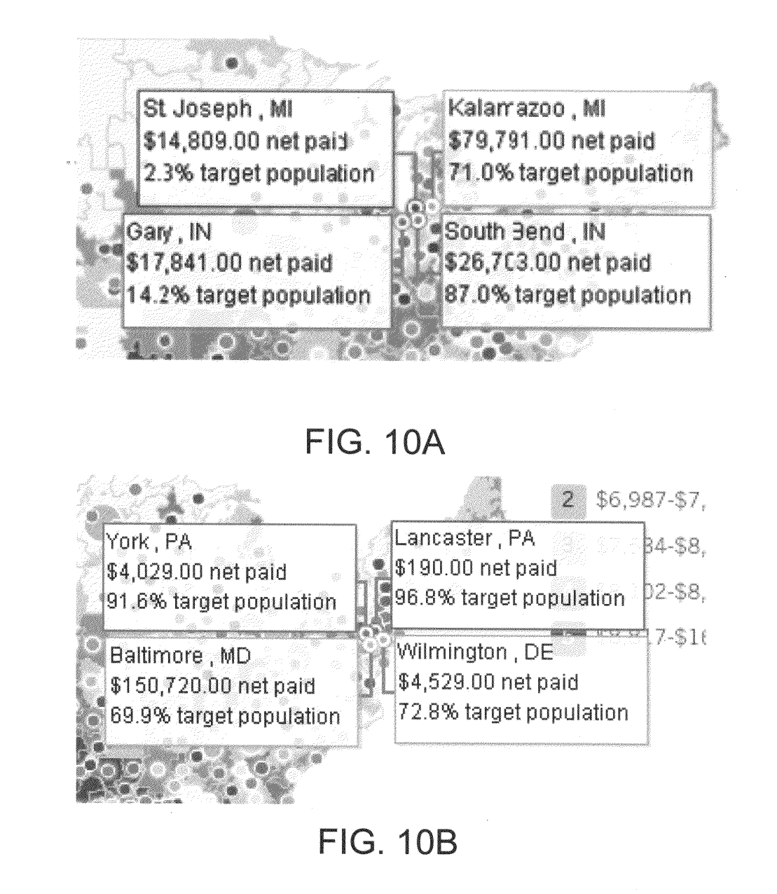

For example, FIG. 10A and FIG. 10B illustrate embodiments of the analysis of clinical data. In this embodiment a bubble is displayed for each geographic region. The size of the bubble corresponds to the net paid statistic with the healthcare region, and the shade of the bubble corresponds to that geographic regions share of the cost. Additionally, both figures illustrate that additional information may be available by mousing over, clicking, or otherwise selecting a bubble. Here, the net paid statistic and target population percentage are displayed. As shown in FIG. 10A, Kalamazoo has costs more than four times higher than Gary or St. Joseph. Such an analysis reveals which areas of the country may need further investigation to determine what explains the difference.

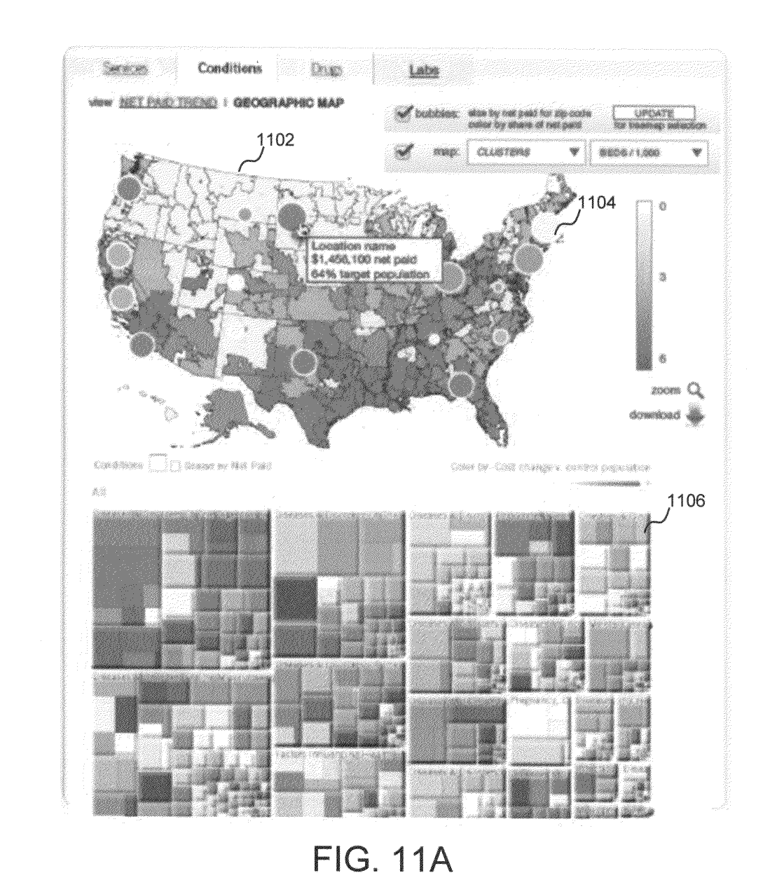

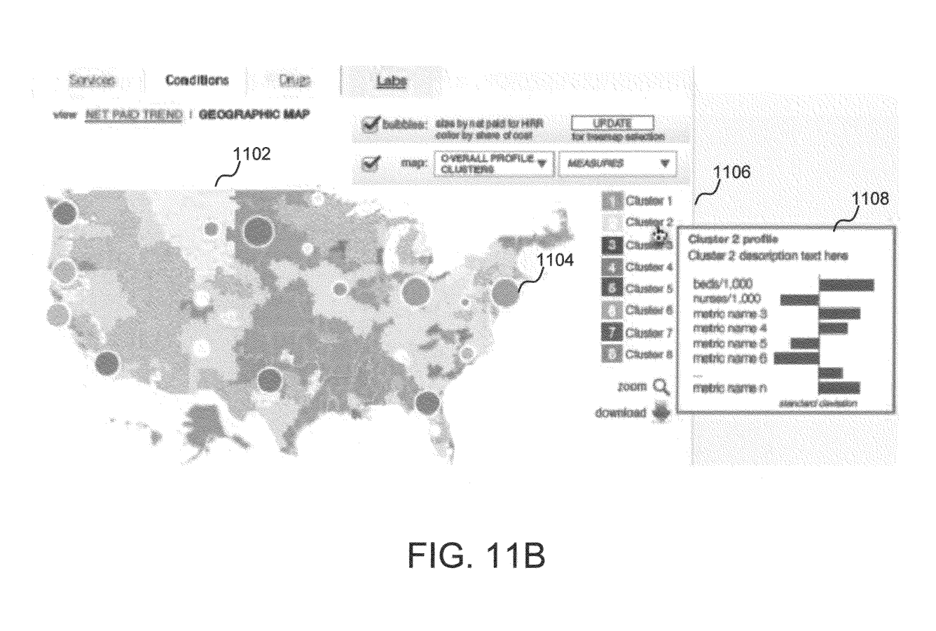

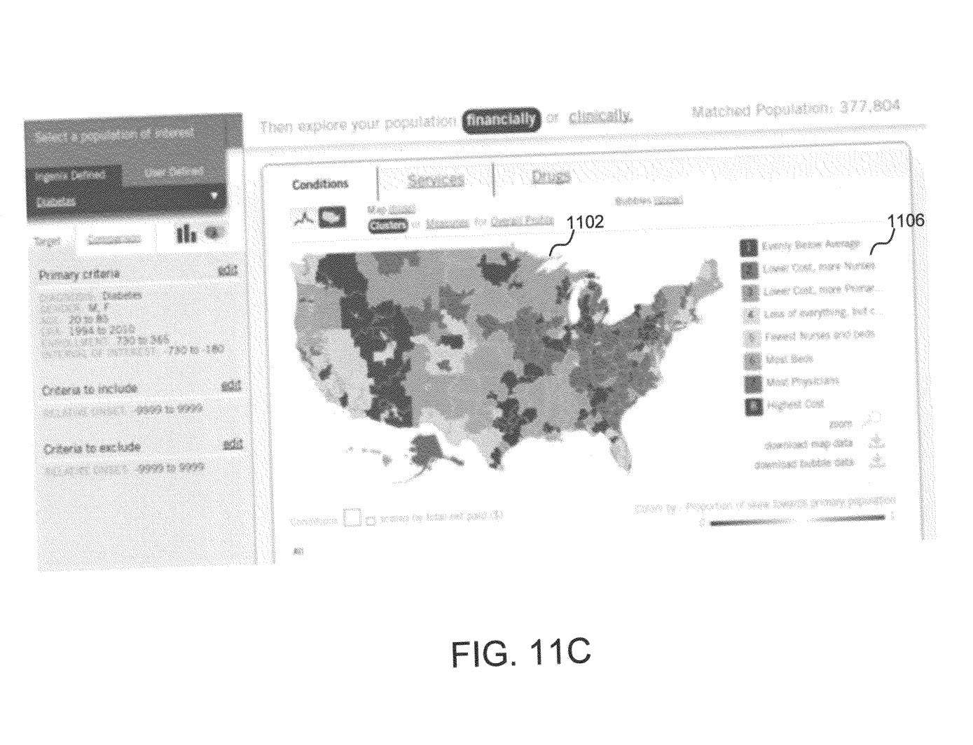

FIG. 11A-C are screenshot diagrams illustrating embodiments of user interface displays. With respect to FIG. 11A, the map 1102 of the United States shows in combination the display of the analysis of healthcare variables and the analysis of clinical data. Moreover, the analysis of the healthcare variables is shown in the “background” of the map 1102. Coloring each of the geographic regions identifies which cluster they are assigned to. This particular screenshot uses simple clusters describing how many hospital beds per 1,000 may be found in a particular geographic region. The analysis of the clinical data is shown through the bubbles, for example bubble 1104. Rather than displaying the bubble associated with each geographic region, in this screenshot, only a few bubbles are shown. Users may selectively define which bubbles are shown, and in some embodiments may set a threshold based on the primary magnitude and/or the secondary magnitude. Additionally, with respect to FIG. 11A, a treemap 1106 is used to display the total of the primary and secondary measure without regard to geography, but subdivided by a hierarchy of diagnoses, procedures, pharmaceuticals and/or other medical facts. The area of each rectangle correlates to the magnitude of the primary measure and the shade correlates with the secondary measure. In this embodiment the treemap 1106 shows in a single rectangle each diagnosis code where the area of the rectangle is the total cost and the color is the bias in the cost to the primary population.

FIG. 11B also illustrates in combination the display of the analysis of healthcare variables and the analysis of clinical data. As shown, this particular screenshot uses 8 complex clusters labeled by cluster number. These clusters are shown in the cluster legend 1106. Additionally, pop-up window 1108—displayed on mouse-over and akin to FIG. 9—illustrates (1) which healthcare variables were analyzed (2) and characteristics of the geographic regions within the clusters based on those healthcare variables.

FIG. 11C illustrates the display of the analysis of healthcare variables. Users may optionally select to only display such geographic clustering information or only to display the analysis of clinical data. In this screenshot, as shown in cluster legend 1106, the geographic regions are assigned to 8 different clusters. Also as shown, each of the clusters are named with a descriptive label. For example, cluster 6 is named the “Most Beds” cluster indicating that the geographic regions assigned to that cluster have a higher than average number of beds when compared to the other regions.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for comparing healthcare data comprising:
receiving healthcare data for geographic regions, the healthcare data comprising:
healthcare variables; and
clinical data;
analyzing, with a processing device, one or more healthcare variables for geographic regions, where analyzing the one or more healthcare variables comprises:
assigning each geographic region to one of N clusters in response to the one or more healthcare variables, where N is a number greater than 1; and
analyzing, with a processing device, the clinical data for geographic regions, where analyzing the clinical data comprises:
determining a primary magnitude for each geographic region of a primary measure;
determining a secondary magnitude for each geographic region of a secondary measure; and
comparing the primary magnitude to the secondary magnitude for each geographic region.

2. The method of claim 1, where analyzing the one or more healthcare variables comprises displaying the analysis of the one or more healthcare variables.

3. The method of claim 2, where displaying the analysis of the one or more healthcare variables comprises:
identifying which geographic region is defined to which one of N clusters; and
identifying the one or more healthcare variables.

4. The method of claim 1 further comprising:
receiving one or more user inputs.

5. The method of claim 1, where analyzing the one or more healthcare variables comprises an iterative process.

6. The method of claim 1, where:
the primary measure comprising a target measure; and
the secondary measure comprising a control measure.

7. The method of claim 1, where analyzing the clinical data further comprises displaying the analysis of the clinical data.

8. The method of claim 7, where displaying the analysis comprises:
displaying the primary magnitude;
displaying the comparison of the primary magnitude to the secondary magnitude.

9. The method of claim 8, where:
displaying the primary magnitude comprises illustrating a circle whose size correlates to the primary magnitude; and
displaying the comparison comprises shading the circle to correlate to the comparison.

10. A system comprising:
a data storage device configured to store healthcare data for geographic regions, the healthcare data comprising:
healthcare variables; and
clinical data;
a server comprising:
a healthcare variable analysis module configured to analyze one or more healthcare variables for geographic regions, where analyzing the one or more healthcare variables comprises:
assigning each geographic region to one of N clusters in response to the one or more healthcare variables, where N is a number greater than 1; and
a clinical data analysis module configured to analyze the clinical data for geographic regions, where analyzing the clinical data comprises:
determining a primary magnitude for each geographic region of a primary measure;
determining a secondary magnitude for each geographic region of a secondary measure; and
comparing the primary magnitude to the secondary magnitude for each geographic region.

11. The system of claim 10, where analyzing the one or more healthcare variables comprises displaying the analysis of the one or more healthcare variables.

12. The system of claim 11, where displaying the analysis of the one or more healthcare variables comprises:
identifying which geographic region is defined to which one of N clusters; and
identifying the one or more healthcare variables.

13. The system of claim 10 further comprising:
user-input module configured to receive one or more user inputs.

14. The system of claim 10, where analyzing the one or more healthcare variables comprises an iterative process.

15. The system of claim 10, where:
the primary measure comprising a target measure; and
the secondary measure comprising a control measure.

16. The system of claim 10, where analyzing the clinical data further comprises displaying the analysis of the clinical data.

17. The system of claim 16, where displaying the analysis comprises:
displaying the primary magnitude;
displaying the comparison of the primary magnitude to the secondary magnitude.

18. The system of claim 17, where:
displaying the primary magnitude comprises illustrating a circle whose diameter correlates to the primary magnitude; and
displaying the comparison comprises shading the circle to correlate to the comparison.

19. A computer program product comprising a computer readable medium having computer usable program code executable to perform operations comprising:
receiving healthcare data for geographic regions, the healthcare data comprising:
healthcare variables; and
clinical data;
analyzing one or more healthcare variables for geographic regions, where analyzing the one or more healthcare variables comprises:
assigning each geographic region to one of N clusters in response to the one or more healthcare variables, where N is a number greater than 0; and
analyzing the clinical data for geographic regions, where analyzing the clinical data comprises:
determining a primary magnitude for each geographic region of a primary measure;
determining a secondary magnitude for each geographic region of a secondary measure; and
comparing the primary magnitude to the secondary magnitude for each geographic region.

20. The computer program product of claim 19, where:
analyzing one or more healthcare variables for geographic regions comprises displaying the analysis of the one or more healthcare variables; and
analyzing the clinical data for geographic regions comprises displaying the analysis of the clinical data.
